(19) United States
(12) Patent Application Publication
(10) Pub. No.: US 2002/0139031 A1
(43) Pub. Date: Oct. 3, 2002

(54) Assembly for the production of a dubbing loop for use in tying flies

(76) Inventor: Anthony J. Ragucci, Lakewood, NJ (US)

Correspondence Address: CLIFFORD G. FRAYNE, Suite 7A, 136 Drum Point Road, Brick, NJ, 08723, US

(21) Appl. No.: 10/094,473

(22) Filed: Mar. 8, 2002

Related U.S. Application Data
(60) Provisional application No. 60/275,304, filed on Mar. 14, 2001.

(51) Int. Cl. A01M 1/00; D03J 3/00

(52) U.S. Cl. 43/1; 269/907; 289/17

(57) ABSTRACT

An improved tool for the fabrication of dubbing loops which includes a base member and two vertically oriented opposed pedestal members, one pedestal member having a hook rotatably mounted thereon, the opposing pedestal member having a biasly mounted post with a thread engaging friction slot, there being pivotally mounted between the opposing pedestals, a dubbing platform pivotal to a horizontal plane such that the upper surface when horizontal is in the plane of a string which stretches between the rotatable hook and the post, dubbing material being laid over such thread on the dubbing surface, the thread then being returned to the rotatable hook on the first pedestal and secured which is then rotated so as to twist the thread and intertwine the dubbing material forming a dubbing loop.

### RELATED APPLICATIONS

Applicant claims the benefit of provisional application 60/275,304 filed Mar. 14, 2001.

### BACKGROUND OF THE INVENTION

1. Field of the Invention

The present invention relates to a tool for assembling a dubbing loop for fabrication of imitation insect bodies used in fly tying.

2. Description of the Prior Art

It is a well-known axiom of fly fishing that the angler should “match the hatch”. This translates to the fisherman attempting to choose an artificial fly hook which will match in look, color and size of the specific aquatic or air born insect which is currently being found attractive by fish as a food source. Fisherman can purchase a selection of pre-made fly hooks which can vary in size, shape and color to hopefully match the normal seasonally expected insects. An avid fly fisherman will prefer to fabricate his own fly hooks. This may be done at home prior to the fly fishing season, or during the fly fishing season. Particular avid fly fisherman may also fabricate a fly during the act of fly fishing to match a particular insect.

One of the materials which is used to form the insect body is known as dubbing. It can consist of artificial thread or animal hair such as rabbit, fox, wool, squirrel, raccoon, or synthetic or natural fiber. Forming a dubbed body on a fly hook by hand is a difficult procedure. Typically dubbing material is placed on one side of a fly tying thread which hangs down from the hook. The dubbing material is placed on one side of the thread and the thread is looped around a finger of one hand and drawn over the dubbing material and then wrapped on the hook to form a loop of thread with the dubbing material positioned within the loop. The loop is then twisted to form a dubbed thread which is then wrapped on the hook to form a dubbed body. The difficulty with the aforesaid procedure is maintaining the position of the dubbing material and the inability to repeatedly form the dubbing material into the appropriate shape, i.e. tapered, so as to more clearly mimic the body of an insect.

Applicant's invention comprises a manually operated tool which allows a fly fisherman to fabricate a dubbing loop, even when in the field fly fishing. It provides for a simple and quick method of making a dubbing loop to the desired shape and color so as to match the currently prevalent insects. The dubbing loop is then cut to the desired length and secured to the hook with tying thread.

### OBJECTS OF THE INVENTION

An object of the present invention is to provide for an improved tool for assembling a dubbing loop for fabrication of dubbed bodies for use in fly tying.

Another object of the present invention is to provide for a novel tool which maintains tension on the thread while the desired quantity of dubbing material is positioned.

A still further object of the present invention is to provide for a novel tool for making of a dubbing loop which allows the fly fisherman to control the size and taper of the subsequent dubbed bodies.

### SUMMARY OF THE INVENTION

An improved tool for the fabrication of dubbing loops which includes a base member and two vertically oriented opposed pedestal members, one pedestal member having a hook rotatably mounted thereon, the opposing pedestal member having a biasly mounted post with a thread engaging friction slot, there being pivotally mounted between the opposing pedestals, a dubbing platform pivotal to a horizontal plane such that the upper surface when horizontal is in the plane of a string which stretches between the rotatable hook and the post, dubbing material being laid over such thread on the dubbing surface, the thread then being returned to the rotatable hook on the first pedestal and secured which is then rotated so as to twist the thread and intertwine the dubbing material forming a dubbing loop.

### BRIEF DESCRIPTION OF THE DRAWINGS

These and other objects of the present invention will become evident, particularly when taken in light of the following illustrations wherein:

FIG. 1 is a side view of the assembly;

FIG. 2 is a top view;

FIG. 3 is an end view;

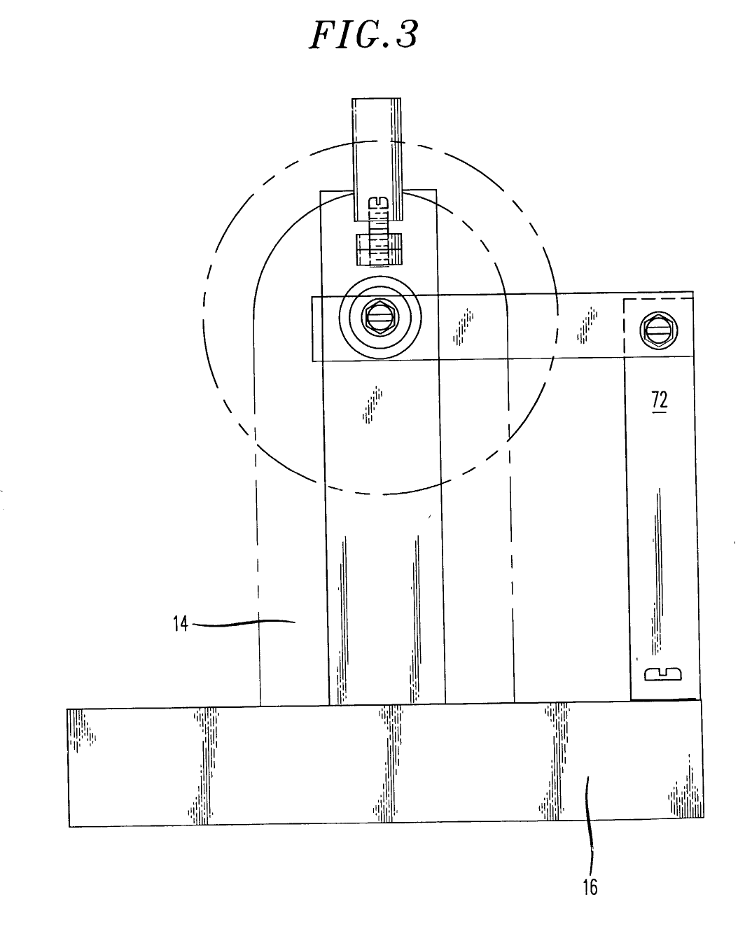

FIG. 4 is a cross section view along plane 4-4 of FIG. 2;

FIG. 5 is a cross section along plane 5-5 of FIG. 2;

FIG. 6 is a cross section along plane 6-6 of FIG. 2;

FIG. 7 is an end view of the platten; and

FIG. 8 is a top view identical to FIG. 2 illustrating the layout of string and dubbing material.

### DETAILED DESCRIPTION OF THE DRAWINGS

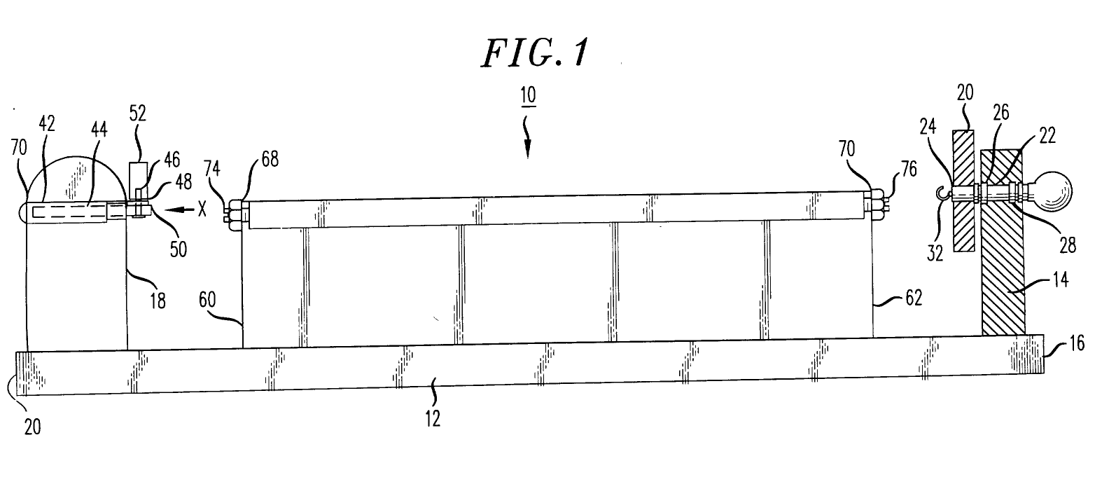

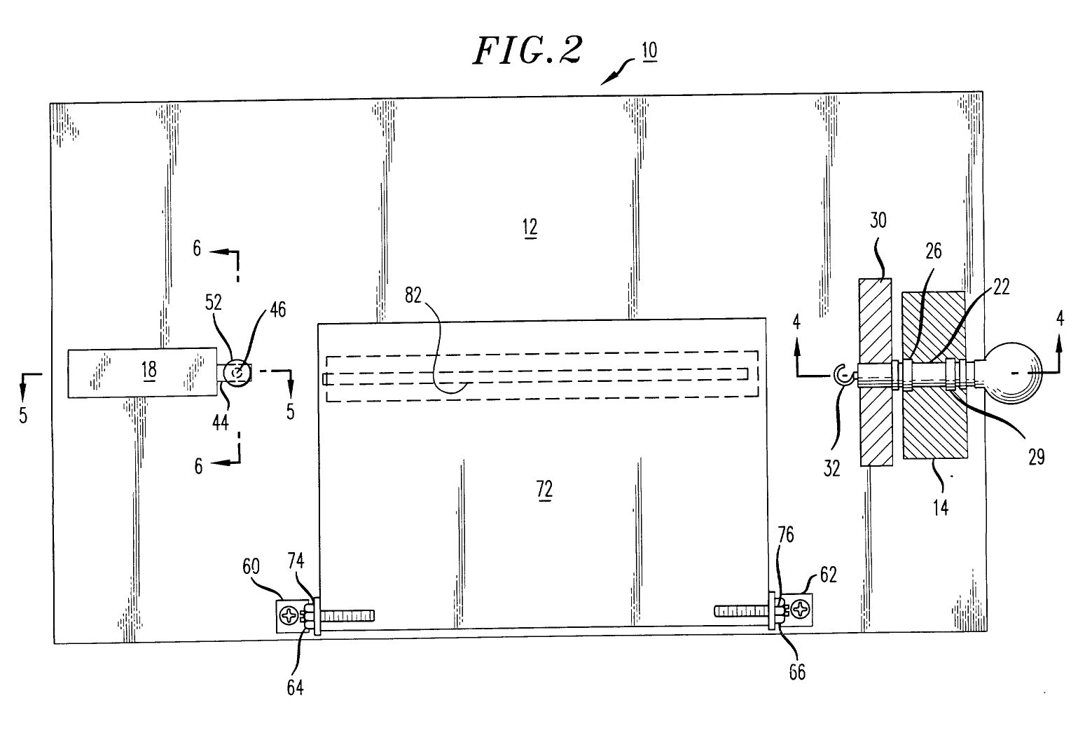

Referring to FIGS. 1 and 2 there is shown a side view and top view of a dubbing assembly 10 of the present invention. Dubbing assembly 10 is formed of a base member 12 of generally rectangular shape having a first pedestal mount 14 secured to a first end 16 of base member 12 and a second pedestal mount 18 secured to second end 20 of base member 12.

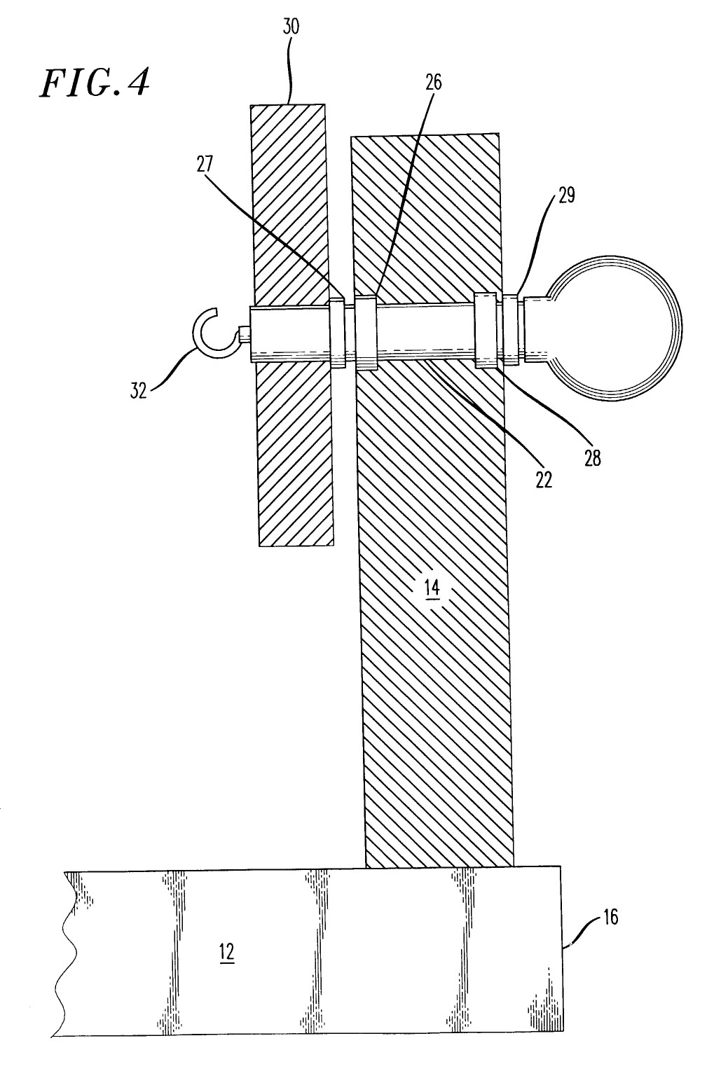

First pedestal mount 14 has a throughbore 22 formed therethrough for receipt of an axle 24 which is mounted in said throughbore on bearing surfaces 26 and 28 (see FIG. 4 for detail). Axle 24 extends inwardly through first pedestal mount 14 a distance sufficient to allow the mounting thereon of a fly wheel member 30. Centrally disposed on axle member 24 on end 25 is a hook member 32. That portion of axle 24 which extends outwardly from first pedestal mount 14 has secured thereon a lever or knob member 34 for the manual rotation of axle 24 and fly wheel 30 and hook 32. Washers 27 and 29 may be disposed on axle 22 adjacent the bearing surfaces 26 and 28.

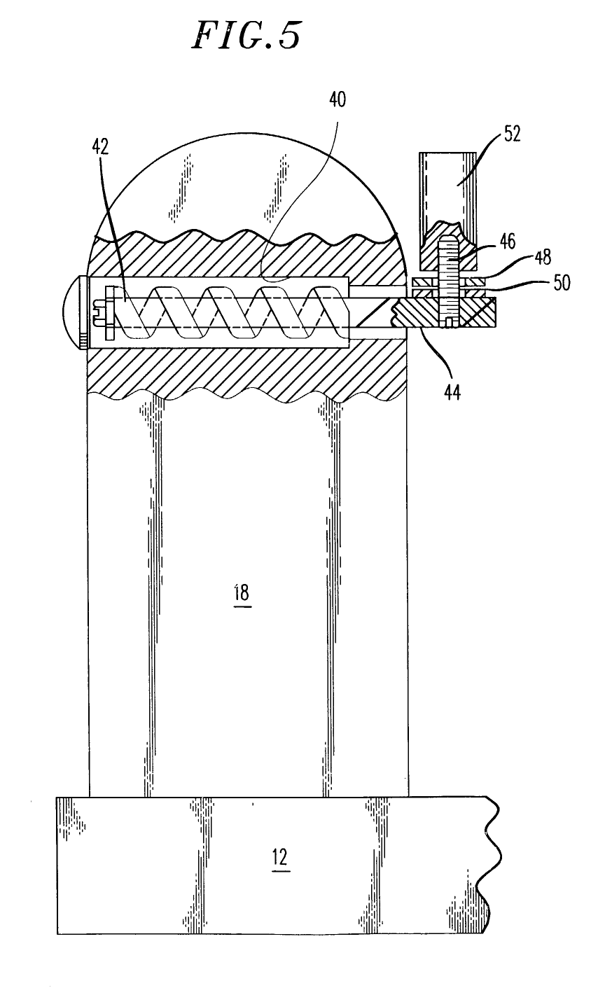

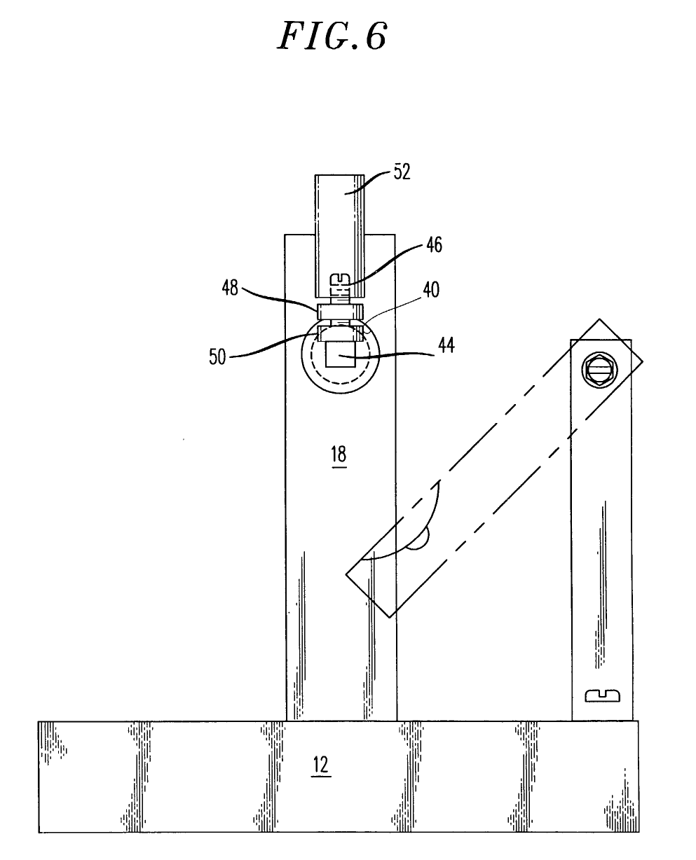

Second pedestal mount 18 is positioned at the opposing end of base member 12 and has a bore 40 formed therein for the positioning of a biasing means 42 and retaining rod 44. Retaining rod 44 extends from second pedestal member 18 in the direction of the first pedestal member 14. Secured to retaining rod 44 in a vertical orientation is a post member 46 on which there is positioned two disk members 48 and 50 in juxtaposed relationship, there being a threaded tightening nut 52 disposed on post member 46 so as to tighten disk members 48 and 50 in friction relationship. This is illustrated in greater detail in FIGS. 5 and 6 which are a side cross sectional view and an end cross sectional view.

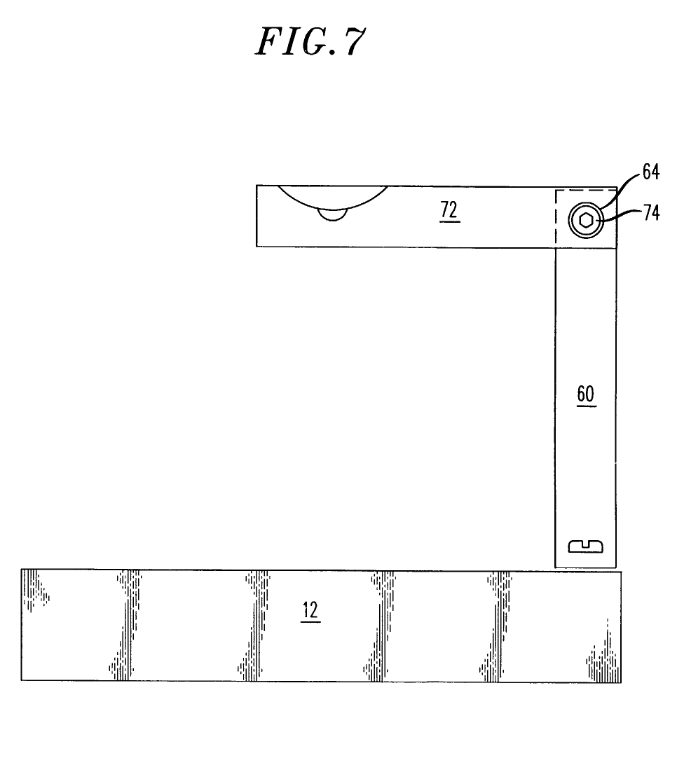

Positioned between first pedestal mount 14 and second pedestal mount 18 on base member 12 proximate to one longitudinal edge thereof are bracket members 60 and 62. Brackets 60 and 62 have apertures 64 and 66 therethrough proximate their vertical terminus 68 and 70. A platten member 72 is secured to the vertical terminus 68 and 70 of brackets 60 and 62 in rotatable relationship from a vertical (not in use) position in which platten member 72 is juxtaposed in a vertical orientation between brackets 60 and 62 to a horizontal (in use) position, in which platten 72 forms an intermediate raised surface between first pedestal mount 14 and second pedestal mount 16. In FIG. 1, platten 72 is illustrated in a horizontal (in use) position. This is the same with respect to that illustrated in FIGS. 2 and 7. The platten 72 is rotatably positioned through the use of threaded fasteners 74 and 76 secured apertures 64 and 66 of bracket members 60 and 62.

Formed on the upper surface of platten 72 is a first longitudinal arcuate groove 80 which is in alignment with hook 32 on first pedestal 14 and post 46 on second pedestal 18. There is further formed within longitudinal arcuate channel 80, a second longitudinal arcuate channel 82 again, in alignment with hook 32 on first pedestal 14 and post 46 on second pedestal 18.

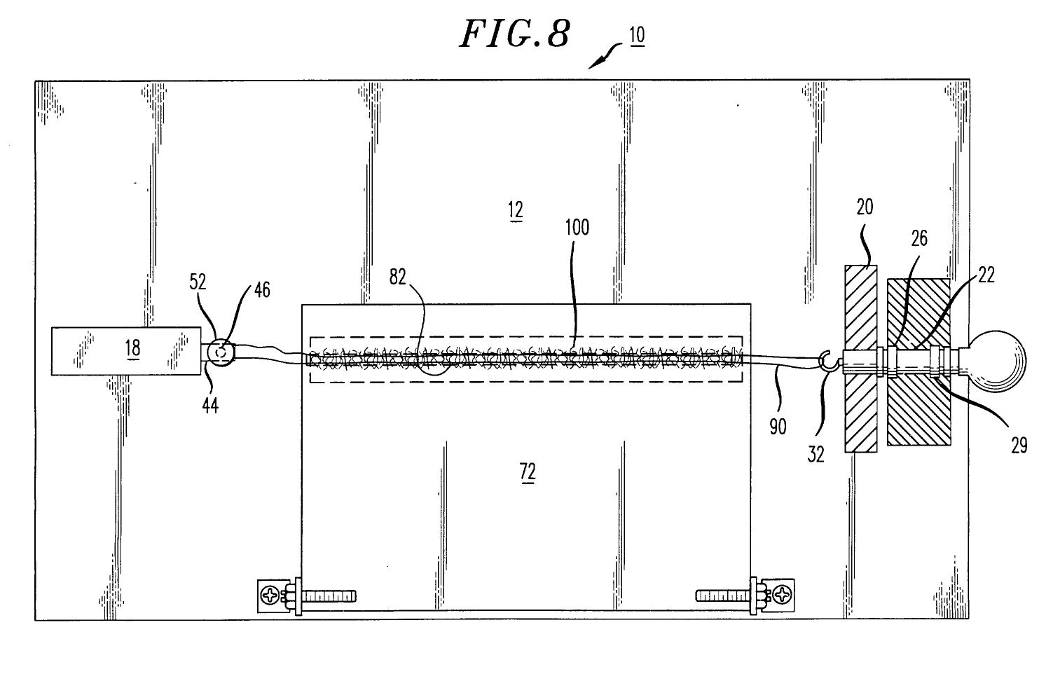

The assembly having thus been described, attention will be given to FIG. 8 which will describe the operation of the assembly. Platten 72 would be rotated into a horizontal position such that longitudinal arcuate channels 80 and 82 are in alignment with hook 32 and post 46. A string, thread or wire 90 would be looped or tied to hook 32 and extended towards post 46. The thread or string would be looped about post 46 between disks 48 and 50 and the desired tension would be placed thereon such that the string or thread 90 lay within longitudinal arcuate channel 82. Thumb screw 52 would be tightened to maintain this desired tension since retaining rod 44 is mounted on the biasing means 42, retaining rod 44 and hence post 46 can move in a horizontal plane towards first pedestal 14. Once the string or thread 90 has been secured about post 46, dubbing material 100, previously discussed, is positioned in first longitudinal arcuate channel 80 on top of string 90 and preferably in a substantially perpendicular orientation to string 90. The end of string 90 is then positioned in first longitudinal arcuate channel 80 passing over top of the dubbing material 100 and is secured to hook 32. Any excess string or thread would be cut. The user would then begin to turn lever or knob 34 which would rotate axle 22, fly wheel 30, and hook 32. This in turn would impart a twisting reaction to thread or string 90 as respect that portion which lies beneath the dubbing material 100 and that portion which lies above the dubbing material 100. The number of turns of hook 32 increases the number of twists imparted to the respective upper and lower portions of string 90 causing the dubbing material 100 to be caught up in one or more of these twists and eventually resulting in a twisted length of string 90 in which dubbing material 100 extends outwardly therefrom in perpendicular and angularly orientation.

Upon completion of the task, the thumb screw 52 would be loosened and disk 48 removed to allow the loop of string 90 to be removed from post 46 and the loop ends on hook 32 would be removed. The fisherman now has a length of twisted string 90 with the quantity of dubbing material entwisted therein and extending outwardly therefrom. The fisherman would then cut the length of string for the desired length necessary for the fly contemplated and form it into the desired type of body he desired by folding it upon itself one or more times if desired and then tying it to the fly hook to form the body of the fly.

The assembly gives the fisherman the opportunity and discretion to use natural or synthetic fibers or hair fur to form a dubbing loop of a desired color, shade or hue, to match the look, color and size of a specific aquatic or air born insect which is currently being found attractive by fish as a food source.

While the present invention has been described with respect to the exemplary embodiments thereof, it will be recognized by those of ordinary skill in the art that many modifications may be made without departing from the spirit and scope of the invention. Therefore it is manifestly intended that the invention be limited only by the scope of the claims and the equivalence thereof.

I claim:

1. An improved tool for the fabrication of dubbing loops used in fly tying wherein dubbing material is positioned on a length of thread and the thread is drawn over the dubbing material to form a loop of thread with the dubbing material sandwiched in the loop and wherein the loop of thread is twisted for form a dubbing thread, the improved device comprising:
a base member;
two vertically oriented opposed pedestal members, one pedestal member having a hook rotatably mounted thereon, the opposing pedestal member having a biasly mounted post with a thread engaging friction slot;
a pivotally mounted dubbing platform pivotally disposed between said opposing pedestals and pivotal to a horizontal plane such that an upper surface when horizontal is in a plane of a thread which stretches between said rotatable hook and said post;
said biasly mounted post with thread engaging friction slot insuring the proper tension on said thread during said twisting process.
